(19) United States
(12) Patent Application Publication
(10) Pub. No.: US 2022/0156672 A1
(43) Pub. Date: May 19, 2022

(54) INFORMATION PROCESSING APPARATUS AND METHOD

(71) Applicant: NIPPON TELEGRAPH AND TELEPHONE CORPORATION, Tokyo (JP)

(72) Inventors: Yoshiaki SHOJI, Musashino-shi, Tokyo (JP); Masateru INOUE, Musashino-shi, Tokyo (JP); Tomoko SHIBATA, Musashino-shi, Tokyo (JP); Hiroshi YOSHIDA, Musashino-shi, Tokyo (JP)

(73) Assignee: NIPPON TELEGRAPH AND TELEPHONE CORPORATION, Tokyo (JP)

(21) Appl. No.: 17/432,334

(22) PCT Filed: Feb. 21, 2020
(86) PCT No.: PCT/JP2020/007107

§ 371 Date: Aug. 19, 2021

(30) Foreign Application Priority Data
Feb. 22, 2019 (JP) 2019-030362

(51) Int. Cl. G06Q 10/06; G07C 1/12

(52) U.S. Cl. CPC G06Q 10/06398; G07C 1/12; G06Q 10/063114; G06Q 10/06316

(57) ABSTRACT

An information processing apparatus according to an embodiment includes: a registration processing unit configured to register, in a storage device, a work node made up of basic blocks, corresponding to respective processes, connected to each other by a link, the work node including a first node indicating a device/tool used by a worker for performing their work, a second node indicating the worker, a third node indicating a process that is a unit of the work activity, and a fourth node indicating a work target object of the worker in the process; and an analysis processing unit configured to execute analysis processing of analyzing at least one of a history of a work activity performed by a predetermined worker, a history of a work activity performed on a predetermined work target object, and a history indicating a worker and a work target object related to a predetermined work, based on the work node registered in the storage device by the registration processing unit.

### TECHNICAL FIELD

An embodiment of the present invention relates to an information processing apparatus and method.

### BACKGROUND ART

As an example of an apparatus that collects, accumulates, and analyzes data on a person and an object, there is a wearable sensor system including: a wearable sensor terminal that acquires both information on a cardiac function and information on a blood flow from a living body; and a determination device that determines a status of the living body against heat damage, based on the information acquired by the wearable sensor terminal and information on the temperature of the geographical location of the living body (see, for example, Patent Literature 1).

### CITATION LIST

### Patent Literature

Patent Literature 1: JP 2017-038839 A

### SUMMARY OF THE INVENTION

### Technical Problem

Unfortunately, for a target object incapable of outputting a log such as a target object of an outdoor work activity (a network (NW) apparatus for example), a history of the work activity performed thereon would not be recorded unless the work activity itself is intentionally recorded. Thus, a camera or the like needs to be used to collect and accumulate data individually. However, when there are many workers each performing a plurality of work activities using multiple devices, an extremely heavy load is imposed on a worker to check data of each and every one of the multiple devices to see when and what work was performed by which worker.

The present invention is made in view of the above, and an object of the present invention is to provide an information processing apparatus and a method with which information on a work activity performed by a worker can be appropriately managed.

### Means for Solving the Problem

A first aspect of an information processing apparatus according to an embodiment of the present invention for achieving the object includes: a registration processing unit configured to register, in a storage device, a work node made up of basic blocks, corresponding to respective processes, connected to each other by a link, the work node including a first node indicating a device/tool used by a worker for performing a work activity, a second node indicating the worker, a third node indicating a process that is a unit of the work activity, and a fourth node indicating a work target object of the worker in the process; and an analysis processing unit configured to execute analysis processing of analyzing at least one of a history of a work activity performed by a predetermined worker, a history of a work activity performed on a predetermined work target object, and a history indicating a worker and a work target object related to a predetermined work, based on the work node registered in the storage device by the registration processing unit.

According to a second aspect of the information processing apparatus according to the present invention, in the first aspect, the registration processing unit further registers a numerical value related to the work activity performed by the worker in the storage device, and the information processing apparatus further includes a determination processing unit configured to determine a proficiency of the worker in the work activity, based on the numerical value related to the work activity registered by the registration processing unit.

According to a third aspect of the information processing apparatus according to the present invention, in the second aspect, the registration processing unit registers vital-related information on the worker in the storage device, and the determination processing unit executes determination processing of determining the proficiency of the worker for the work, based on information including the numerical value related to the work activity and the vital-related information registered by the registration processing unit.

According to a fourth aspect of the information processing apparatus according to the present invention, in the second or the third aspect, the storage device further stores information indicating an advice to the worker, the advice corresponding to the proficiency of the worker in their work activity, and the information processing apparatus further includes an output processing unit configured to executed output processing of searching the storage device for information indicating the advice corresponding to the work to be performed by the worker and the proficiency determined by the determination processing unit for the work, and outputting the information.

An aspect of an information processing method according to an embodiment of the present invention is an information processing method at an information processing apparatus, the method including: executing registration processing of registering, in a storage device, a work node made up of basic blocks, corresponding to respective processes connected to each other, by a link, the work node including a first node indicating a device/tool used by a worker for a work activity, a second node indicating the worker, a third node indicating a process that is a unit of the work activity, and a fourth node indicating a work target object of the worker in the process; and analyzing at least one of a history of a work activity performed by a predetermined worker, a history of a work activity performed on a predetermined work target object, and a history indicating a worker and a work target object related to a predetermined work, based on the work node registered in the storage device by the registration processing.

### Effects of the Invention

According to the first aspect of the information processing apparatus according to an embodiment of the present invention, at least one of the history of the work activity performed by the predetermined worker, the history of the work activity performed on the predetermined work target object, and the history of the worker and the work target object related to the predetermined work is analyzed, based on the work node registered. Thus, the work can be easily recognized.

According to the second aspect of the information processing apparatus according to an embodiment of the invention, the proficiency of the worker in their work activity determined based on the numerical value related to the work activity. Thus, the worker's proficiency in their work activity may be appropriately acquired.

According to the third aspect of the information processing apparatus according to an embodiment of the invention, the proficiency of the worker in the work activity is determined based on the numerical value related to the work activity and the vital-related information. Thus, the proficiency in the work activity may be appropriately acquired.

According to the fourth aspect of the information processing apparatus according to an embodiment of the present invention, the information indicating an advice corresponding to both the work activity performed by the worker and the proficiency determined for the work activity is output. Thus, appropriate advice based on the worker's proficiency may be provided to the worker.

Thus, with the aspects of the present invention, the information on the work activity performed by the worker can be appropriately managed.

### BRIEF DESCRIPTION OF DRAWINGS

FIG. 1 is a diagram illustrating an application example of a business process analysis system according to one embodiment of the present invention.

FIG. 2 is a diagram illustrating one example of a basic block.

FIG. 3 is a diagram illustrating one example of an overall processing procedure implemented by the business process analysis system according to an embodiment of the present invention.

FIG. 4 is a diagram illustrating one example of generation of a work node.

FIG. 5 is a diagram illustrating one example of registration of actual case data.

FIG. 6 is a diagram illustrating one example of registration of actual case data.

FIG. 7 is a diagram illustrating, in a tabular format, one example of information registered and information not registered by actual case data registration processing executed.

FIG. 8 is a diagram illustrating one example of registration of start time and end time for each process.

FIG. 9 is a diagram illustrating one example of a work node after data accumulation processing.

FIG. 10 is a diagram illustrating, in a tabular format, one example of information registered and information not registered by the data accumulation processing.

FIG. 11 is a diagram illustrating one example of a work node to be analyzed.

FIG. 12 is a diagram illustrating one example of a history of a work activityer.

FIG. 13 is a diagram illustrating one example of a history of a work activity target object.

FIG. 14 is a diagram illustrating one example of a history of a work activity.

FIG. 15 is a flowchart illustrating one example of a processing operation according to work proficiency determination.

FIG. 16 is a diagram illustrating, in a tabular format, one example of information registered through the work proficiency determination processing.

FIG. 17 is a flowchart illustrating one example of a processing operation related to process proficiency determination.

FIG. 18 is a diagram illustrating, in a tabular format, one example of information registered through process proficiency determination processing.

FIG. 19 is a diagram illustrating, in a tabular format, one example of the contents of an advice for a process displayed in accordance with the proficiency.

FIG. 20 is a diagram illustrating, in a tabular format, one example of the contents of an advice displayed in accordance with the proficiency at an appropriate timing.

FIG. 21 is a diagram illustrating one example of a selection condition.

FIG. 22 is a diagram illustrating one example of a configuration of the basic block when a selection condition is applied.

FIG. 23 is a diagram illustrating, in a tabular format, one example of the relationship between extensions and the assigned nodes when a selection condition is applied.

FIG. 24 is a diagram illustrating one example of a configuration of the basic block with device acquired information and a node associated with each other when a selection condition is applied.

FIG. 25 is a block diagram illustrating one example of a hardware configuration of a business process analysis system according to an embodiment of the present invention.

### DESCRIPTION OF EMBODIMENTS

Embodiments according to the present invention will be described below with reference to the drawings.

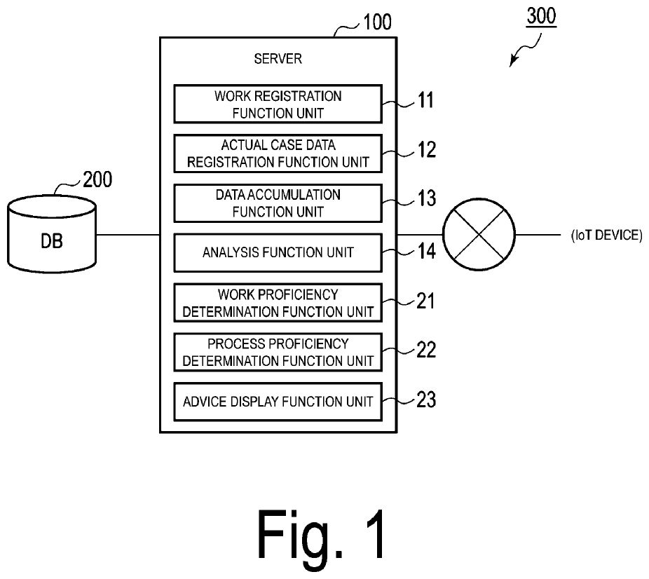

FIG. 1 is a diagram illustrating an application example of a business process analysis system (information processing apparatus) according to one embodiment of the present invention.

As illustrated in FIG. 1, a business process analysis system 300 according to an embodiment of the present invention includes a server (information processing apparatus) 100 and a database (DB) 200. The server 100 is communicatively coupled to an Internet of Things (IoT) device owned by a worker, through a communication network.

The IoT device may be, for example, a full orientation camera (which may also be a normal camera or the like), a smart watch, smart glass, or the like.

The server 100 includes a work registration function unit 11, an actual case data registration function unit 12, a data accumulation function unit 13, an analysis function unit 14, a work proficiency determination function unit 21, a process proficiency determination function unit 22, and an advice display function unit 23.

The database 200 includes storage devices respectively storing actual case data, worker data, various types of work activity data, device/tool data, and work target object data.

The functions of the work registration function unit 11, the actual case data registration function unit 12, the data accumulation function unit 13, the analysis function unit 14, the work proficiency determination function unit 21, the process proficiency determination function unit 22, the advice display function unit 23 of the server 100 and the function of the database 200 can be implemented by a computer and the like using a processor such as a central processing unit (CPU), an input device such as a keyboard, an output device such as a display, and a storage medium such as a random access memory (RAM) or a read only memory (ROM). Operations of each unit will be described below.

The present embodiment is expected to be applied to an engineering work target objecting a work target object that does not output a log such as a NW device.

Examples (1) and (2) of features of an engineering work for a work target object that does not output a log will be described.

(1)

In an engineering work for a work target object that does not output a log, no history is recorded unless the work is intentionally recorded. Although it is possible to obtain logs of various devices, such logs are information insufficient for the purpose of recognition of a business process. In other words, with the logs, recognition and visualization of the work process is difficult. Thus, in the present embodiment, various devices are utilized to acquire, collectively manage, and visualize a wide variety of data so that a data structure with which a business process can be recognized is achieved.

(2)

To begin with, a progress of a work plan is managed in a work site, and there has been a demand from the work site for swift recognition of an impact of a change in the work plan, so that the work site can appropriately deal with the change. However, a change in an engineering procedures for each defined engineering type are reflected after it has been made, making it difficult to swiftly and flexibly dealing with the change.

In view of this, the present embodiment enables a work plan to be changed in real time, through identification of a part of a work plan that needs to be changed which is notified by a worker.

Next, a basic block and work related to a business process analysis system according to an embodiment of the present invention will be described.

Basic Block

The following four types of information are defined as components of the basic block.

Device/Tool: an IoT device and tool used by a worker to perform work.

The IoT device is, for example, a smartphone and a tablet.

Worker: Information about a person performing the work.

This information may include the worker [symbol] work proficiency and process proficiency described later. For a process and a work that have never been implemented, the work proficiency and the process proficiency are defined as “beginner”.

Process: Information indicating a minimum unit as a result of decomposing a work activity performed by the worker into steps.

This information may include a standard duration, a process start time, and a process end time.

Work target object: A target for which the worker performs some sort of operation using the device/tool in a process.

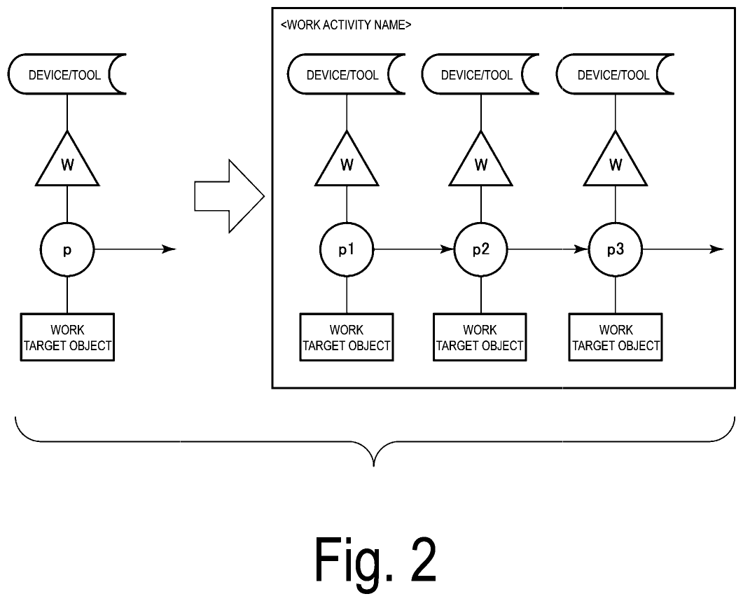

FIG. 2 is a diagram illustrating one example of the basic block.

As illustrated in FIG. 2, the “basic block” consists of (1) four types of nodes that are: “device/tool”, “worker”, “process”, and “work target object”, (2) a link connecting the nodes “device/tool”, “worker”, “process”, and “work target object” in this order, and (3) a link from a node corresponding to the process to a node corresponding to a process in a next work.

The device/tool may include two or more devices/tools as appropriate. In FIG. 2 (left side), the node “worker” in the basic block described above is denoted by “w” which is the acronym of the word “worker”, and the node “process” is denoted by “p” which is the acronym of the word “process”.

In the basic block, information pieces on nodes that are linked are associated with each other. For example, when the operator searches for/views the information on the node “worker” in the basic block using a computer or the like, the start/end time of the process, the information on the node “device/tool”, and the information on the node “work target object” are displayed while being linked to each other.

Work

As illustrated in FIG. 2, a “work” (hereinafter, may also be referred to as a work node) is defined as a node including a plurality of basic blocks and a node that is an outer frame enclosing these basic blocks.

The number of the plurality of basic blocks in the work node corresponds to the number of processes as a result of decomposing the work into steps. Each node of the plurality of basic blocks in the work node is also linked to the work node. The work node includes a work activity name.

In FIG. 2 (right side), the node “worker” in each basic block in the work node described above is denoted by “w”.

Furthermore, in FIG. 2 (right side), “p1” denotes a node “process” in the first basic block (in the executed order of processes) in the work node described above, “p2” denotes a node “process” in the second basic block, “p3” denotes a node “process” in the third basic block.

Next, an analyst and an overall processing procedure will be described.

About Analyst

In the present embodiment, analyst is defined as a person in charge of gathering information on a work activity performed by a worker before or after the work is performed.

About Operation Procedure

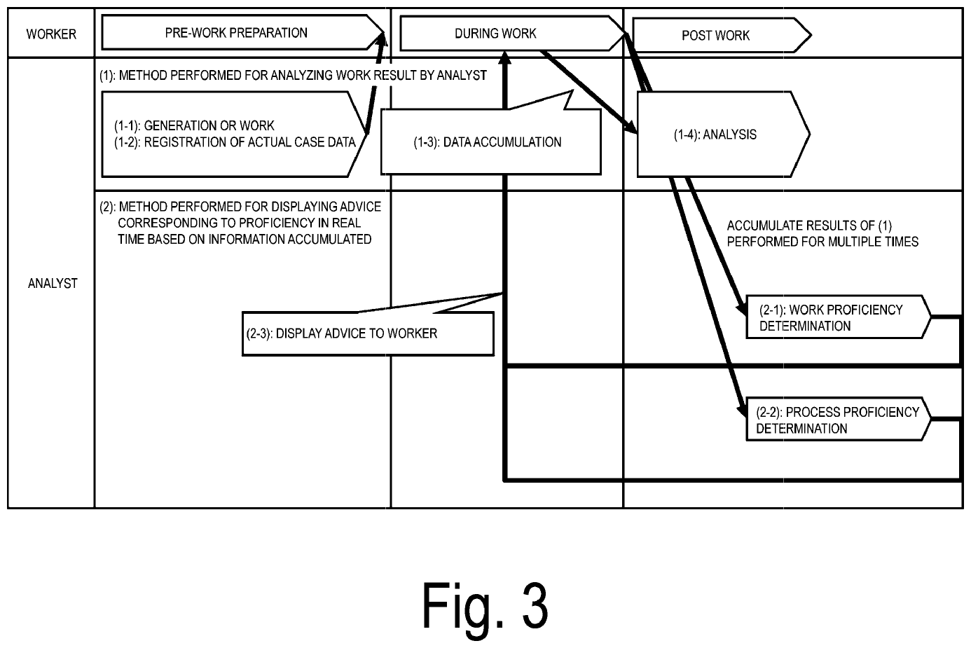

FIG. 3 is a diagram illustrating one example of an overall processing procedure implemented by a business process analysis system according to an embodiment of the present invention.

As illustrated in FIG. 3, a work procedure performed by a worker is divided into pre-work preparation, during work, and post-work.

A processing procedure involving by the analysts include (1) and (2) below.

(1) Processing procedure in which analyst analyzes work result

(2) Processing procedure in which advice corresponding to proficiency of worker is displayed in real time, based on information accumulated in database 200.

The above (1) is divided into (1-1), (1-2), (1-3), and (1-4) below.

(1-1) Generation of work node by analyst

(1-2) Registration of actual case data by analyst

(1-3) Data accumulation

(1-4) Analysis

The above (1-1) and (1-2) are performed in the pre-work preparation, (1-3) is performed during work, and (1-4) is performed in the post-work.

The above (2) is divided into (2-1), (2-2), and (2-3) below.

(2-1) Determination of work proficiency

(2-2) Determination of process proficiency

(2-3) Display advice to worker

The above described (2-1) and (2-2) are performed in the post-work based on a result of the data accumulation in (1) described above, and (2-3) is performed in the next work based on a result of the determination in (2-1) and (2-2) in the previous work.

Next, a description will be given on the above (1-1): Generation of work node by analyst.

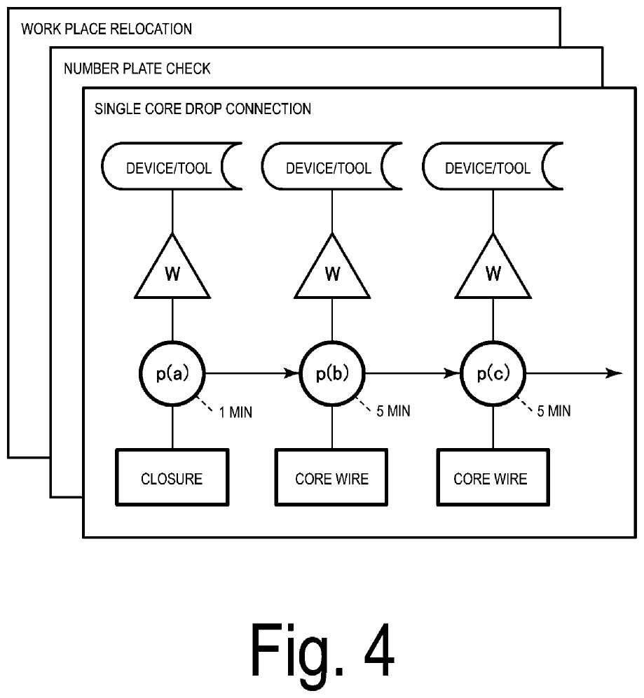

The work registration function unit 11 of the server 100 executes processing to implement the above (1-1) including the following (1-1-1), (1-1-2), and (1-1-3). FIG. 4 is a diagram illustrating one example of generation of a work node.

(1-1-1)

In response to an operation performed by an analyst, the work registration function unit 11 links a plurality of basic blocks to generate a work node, and determines a work activity name indicating a type of the work node. In the example illustrated in FIG. 4, the work activity name is a single core drop connection, a number plate confirmation, and a workplace relocation.

(1-1-2)

In accordance with an operation by the analyst, a process name is defined that indicates a type of the node “process” in each basic block, and the type of the node “work target object” is determined in accordance with the process. In the example illustrated in FIG. 4, the type of node “step” includes “opening lid”, “core wire processing target”, and “single core separation” in the single core drop connection. These “opening lid”, “core wire processing target”, and “single core separation” respectively correspond to “p(a)”, “p(b)”, and “p(c)” illustrated in FIG. 4 on one-to-one basis.

The type of node “work target object” indicates several types of classifications of the node “work target object” such as a utility pole, closure, and core wire.

In the above (1-2) performed later, a unique identification (ID) for each type of node “work target object” in the work actually performed is registered in the database 200. The ID for each type of node “work target object” is, for example, “No. XXX”. Furthermore, the device/tool name may be registered in the database 200 as the type of node “device/tool.”

(1-1-3)

In accordance with the operation by the analyst, the work registration function unit 11 sets a standard duration (e.g., 1 minute or 5 minutes) to each node “process” in each basic block. With (1-1-1), (1-1-2), and (1-1-3) above, the work registration function unit 11 can set a type of a node related to an ID (hereinafter, may be referred to as actual case data) determined later, the node being one of the work node of the actual work, the node “worker”, the node “work target object”, and the node “device/tool”.

In one example illustrated in FIG. 4, a work activity name “single core drop connection” of a work node is registered in the database 200 for the work node. The type “opening lid” as the node “process” in the first basic block (in the order of the processes performed) in the work node, as well as “1 minute” as the standard duration of the process and “closure” as the type of the node “work target object” of the process are registered in the database 200.

Furthermore, the type “single core wire processing target” of the node “process” in the second basic block in the work node, as well as “5 minutes” as the standard duration of the process and the type “core wire” as the type of the node “work target object” are registered in the database 200.

Furthermore, the type “single core separation” of the node “process” in the third basic block in the work node, as well as “5 minutes” as the standard duration of the process and the type “core wire” as the type of the node “work target object” are registered in the database 200.

FIG. 4 illustrates the types thus registered. The type “opening lid” of the node “process” in the first basic block is denoted by “p(a)”, the type “core wire processing target” in the second basic block is denoted by “p(b)”, and the type “single core separation” in the third basic block is denoted by “p(c)”. The standard duration will be omitted from the drawings thereafter. Furthermore, the nodes “device/tool” in the first, second, and third basic blocks may be denoted as “device/tool A”, “device/tool B”, and “device/tool C”, respectively.

Next, a description will be given on the above (1-2): registration of actual case data by analyst.

(1-2) is realized by processing by the actual case data registration function unit 12 of the server 100, and is divided into the following (1-2-1) and (1-2-2).

(1-2-1)

In accordance with an operation by the analyst, the actual case data registration function unit 12 registers the actual case data on the work node, the actual case data on the node “worker”, and the actual case data on the node “work target object” in the database 200.

If the node “worker” is not assigned in advance, an operation is performed under selection conditions A-2 and B-2 described later.

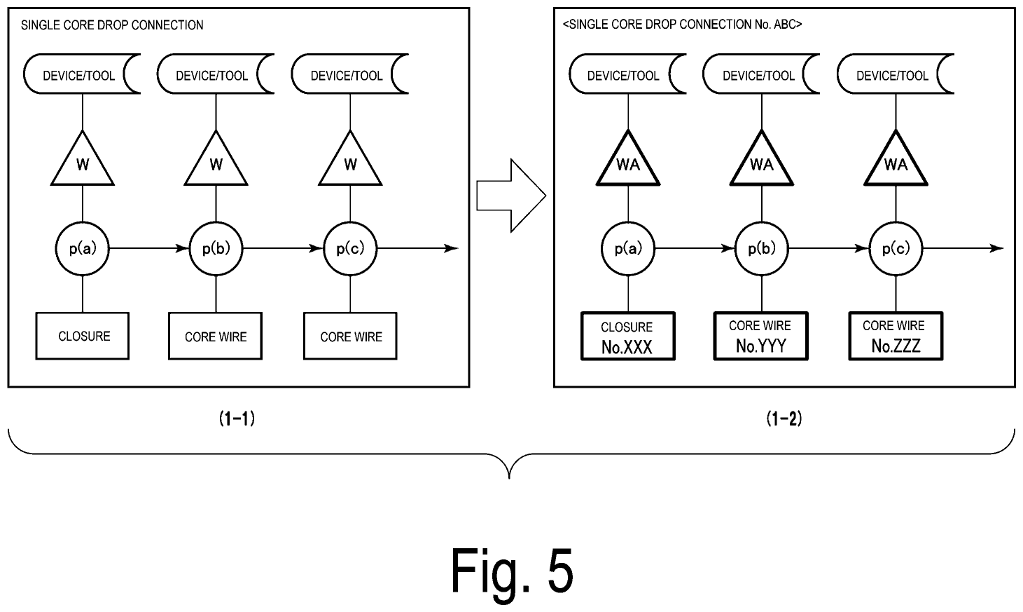

FIG. 5 is a diagram illustrating one example of registration of actual case data. FIG. 5 (left side) illustrates the work node generated in (1-1).

As illustrated in FIG. 5 (right side), actual case data “No. ABC” on the work node generated in (1-1) is registered in the database 200. The actual case data on the work node is information unique to each work, and may be referred to as a work ID.

Actual case data “worker A” on the node “worker” in the first basic block in the work node, and actual case data “No. XXX” related to the type “closure” of the node “work target object” are registered in the database 200. The actual case data on the node “worker” is information unique to each target worker and is, for example, the name of the worker. The actual case data on the node “work target object” is information unique to each work target object, and may be referred to as a work target object ID.

The actual case data “worker A” on the node “worker” in the second basic block and actual case data “No. YYY” related to the type “core wire” of the node “work target object” are registered in the database 200.

The actual case data “worker A” on the node “worker” in the third basic block and actual case data “No. ZZZ” related to the type “core wire” of the node “work target object” are registered in the database 200.

The actual case data on the node “worker” described above registered in the database 200 may include the work proficiency of the worker when he or she is a beginner and process proficiency which is proficiency related to the process when the worker is a beginner.

FIG. 5 illustrates the actual case data registered as described above. It should be noted that “WA” denotes the actual case data “worker A” on the node “worker” in each basic block in the work node described above.

(1-2-2)

In accordance with an operation by the analyst, the actual case data registration function unit 12 registers actual case data on the node “device/tool”. Here, it is assumed that a node “device/tool” for a node “worker” in the basic block is assigned in advance in accordance with the operation by the analyst.

When this node “device/tool” is not assigned in advance, or if the type of node “device/tool” is changed in accordance with an operation of the worker, an operation is performed under a selection condition A-2 described later.

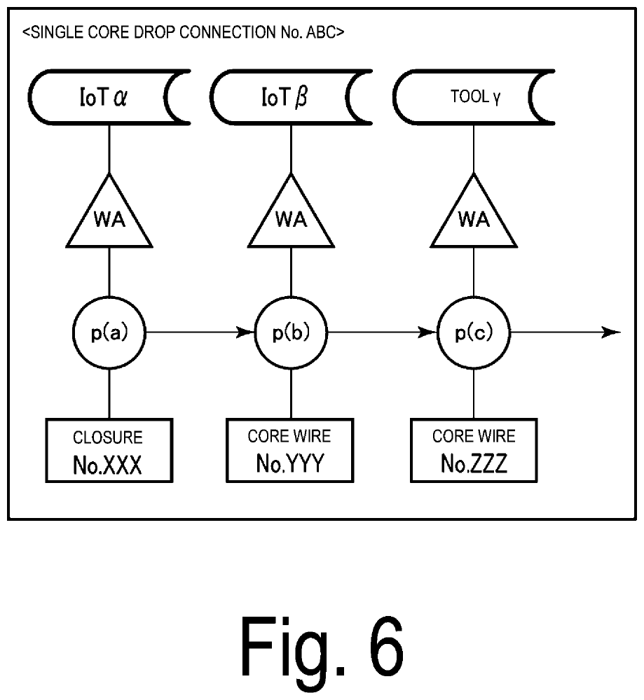

FIG. 6 is a diagram illustrating one example of registration of actual case data.

In the example illustrated in FIG. 6, actual case data “IoT α” on the node “device/tool” in the first basic block in the work node generated in (1-2-1), actual case data “IoT β” on the node “device/tool” in the second basic block, and actual case data “tool γ” on the node “device/tool” in the third basic block are registered in the database 200.

The actual case data on the node “device/tool” is information unique to a device/tool and may be referred to as a device/tool ID.

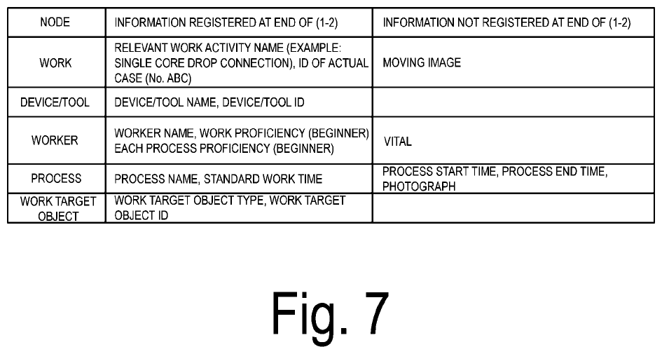

FIG. 7 is a diagram illustrating, in a tabular format, one example of information registered and information not registered by the actual case data registration processing executed.

In the example illustrated in FIG. 7, information registered in the database 200 at the point when the processing related to the above (1-2) ends and information not registered in the database 200 at the point when the processing ends are illustrated for each type of node.

One example of the information registered in the database 200 at the point when the processing related to (1-2) for various types of nodes ends will be described below.

(Node “work”) work activity name (example: single core drop connection), actual case ID (example No. ABC)

(Node “device/tool”) device/tool name, device/tool ID

(Node “worker”) worker name, work proficiency (beginner), each process proficiency (beginner)

(Node “process”) process name, standard work time

(Node “work target object”) work target object type, work target object ID

One example of the information not registered in the database 200 at the point when the processing related to (1-2) for various types of nodes ends will be described below.

(Node “work”) moving image

(Node “worker”) vital

(Node “process”), process start time, process end time, photograph

One example of the information related to (1-2) is as described above.

Next, a description will be given on (1-3): data accumulation.

The data accumulation function unit 13 of the server 100 executes processing to implement (1-3) divided into (1-3-1), (1-3-2), (1-3-3), and (1-3-4) below.

(1-3-1)

The data accumulation function unit 13 notifies the worker corresponding to the actual case data “worker A” described above (hereinafter, may be simply referred to as “worker A”) of the process through an IoT device which is a device (hereinafter, may be simply referred to as “IoT α”) corresponding to the ID “IoT α” herein, and a smartphone.

When the worker A inputs start/end of a process through an operation on a button of a user interface (UI) of the IoT α, through a voice input through a microphone, or the like, the data accumulation function unit 13 stores the start/end time of each process in the database 200.

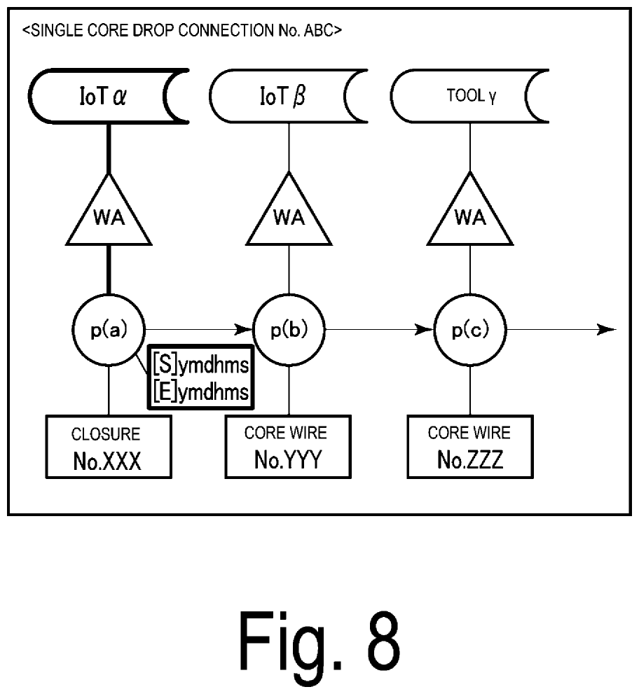

FIG. 8 is a diagram illustrating an example of registration of start time and end time for each process.

The example illustrated in FIG. 8 is one example of registration of start/end time for the registration result illustrated in FIG. 6. In this example, the start time is “[s]ymdhms” corresponding to each of the year, month, day, hour, minute, and second, and the end time is “[E]ymdhms” corresponding to each of the year, month, day, hour, minute, and second.

(1-3-2)

As one example, in a case where the worker A records a photograph taken during the process using the IoT α, the data accumulation function unit 13 stores image information (data on the photograph taken) in the database 200 as information related to the process, in accordance with the operation by the worker.

(1-3-3)

As one example, when the worker records vital data such as his or her heartbeat using the IoT α, the data accumulation function unit 13 stores the vital data in the database 200 as information related to the worker A, in accordance with the operation by the worker.

(1-3-4)

As one example, when the worker records a work moving image using the IoT α, the data accumulation function unit 13 stores the work activity name and the work moving image information in the database 200 as information related to “single core drop connection No. ABC” that is an ID of the actual case, in accordance with the operation by the worker.

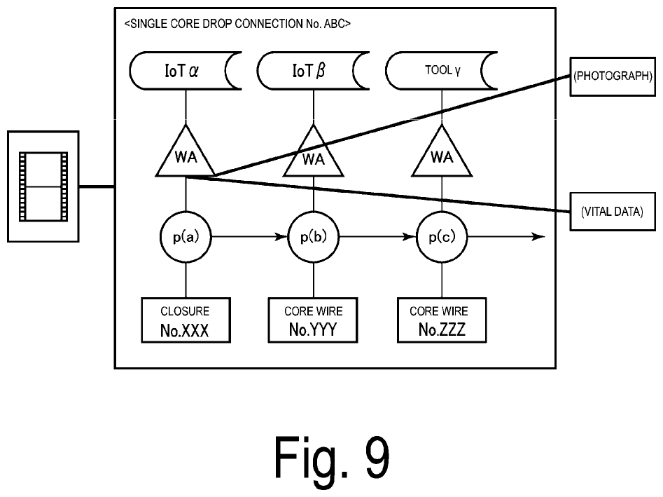

FIG. 9 is a diagram illustrating one example of a work node after the data accumulation processing.

In the example illustrated in FIG. 9, the work moving image is associated with the work node, and the photograph taken during the process and the vital data of the worker A him or herself are associated with the node “worker” in the first basic block.

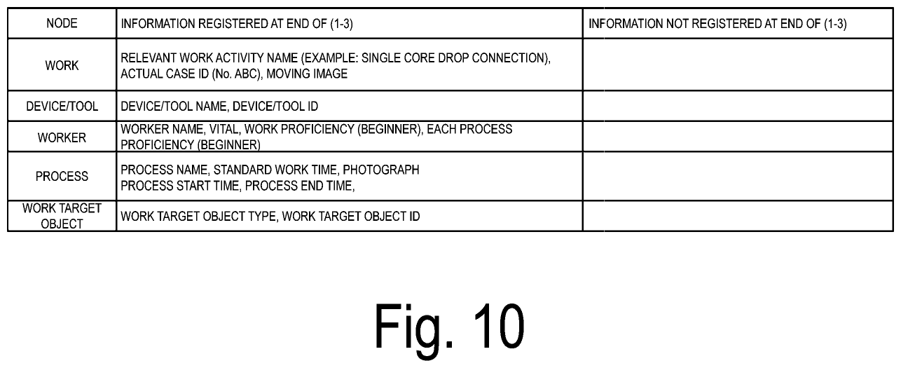

FIG. 10 is a diagram illustrating, in a tabular format, one example of information registered and not registered information by the data accumulation processing.

In the example illustrated in FIG. 10, the information not registered in the database at the end of the processing related to the above (1-2) illustrated in FIG. 7 is combined with the information registered in the database 200 at the end of the processing related to the above (1-3).

As a result, the information not registered in the database 200 at the end of the processing related to the above (1-2) no longer exists at the end of the process related to the above (1-3). As characteristics of the basic block and work, the various types of information stored in the database 200 are automatically linked to the nodes, and thus the acquired information is collectively managed.

Next, a description will be given on (1-4): analysis by the analyst.

The analysis function unit 14 of the server 100 executes processing to implement (1-4).

The information pieces obtained in (1-3) and before are collectively managed. Based on the information, the analysis function unit 14 may analyze a history of the worker, a history of the work target object, and a history of the work as described later, by following the links in terms of human (worker), object (work target object, a device/tool), and operation (work, procedure).

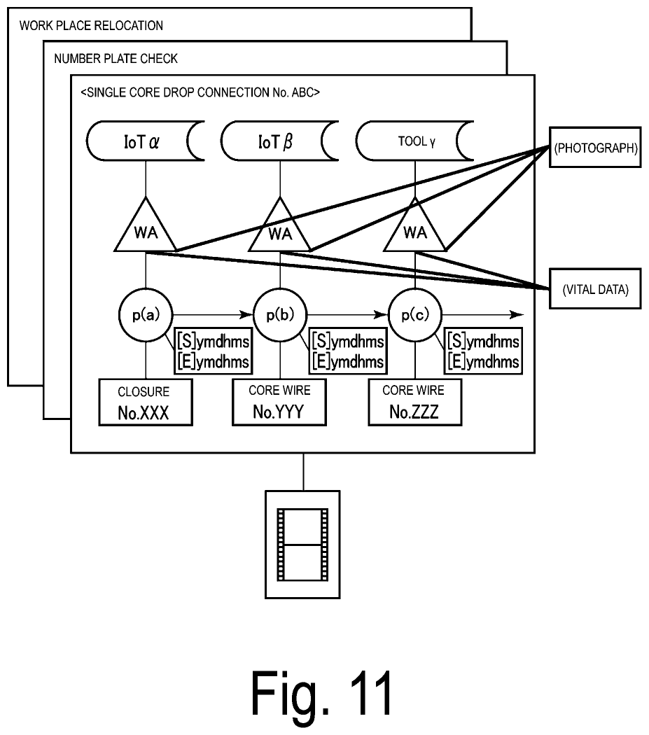

FIG. 11 is a diagram illustrating one example of a work node to be analyzed.

As illustrated in FIG. 11, this work node to be analyzed is associated with the work moving image. Furthermore, image information on a process is associated with each node “worker” in each basic block, and vital data on the worker him of herself is associated with a node “worker” in each basic block.

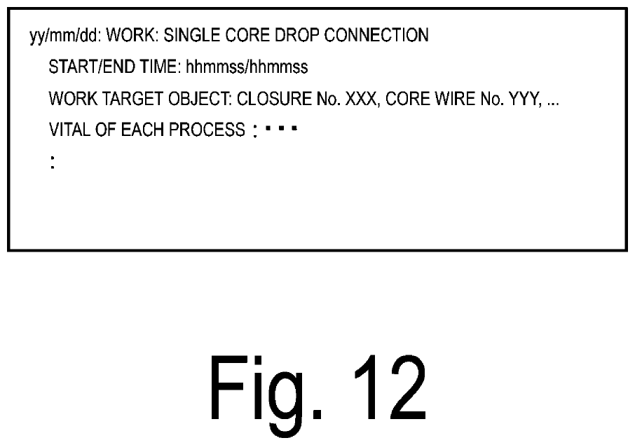

FIG. 12 is a diagram illustrating one example of a history of a worker.

In the example illustrated in FIG. 12, the history of the worker A in each basic block displayed as an analysis result for each work node includes: (1) date of work; (2) work activity name; (3) process start/end time; (4) type and ID of work target object; (5) vital of the worker him or herself in each process; and (6) image information which is a photograph taken during the process.

While only the image and the vital data are associated with a work node with the work activity name “work single core drop connection”, the analysis can be facilitated by also displaying the information associated with another work node that is linked with the work node.

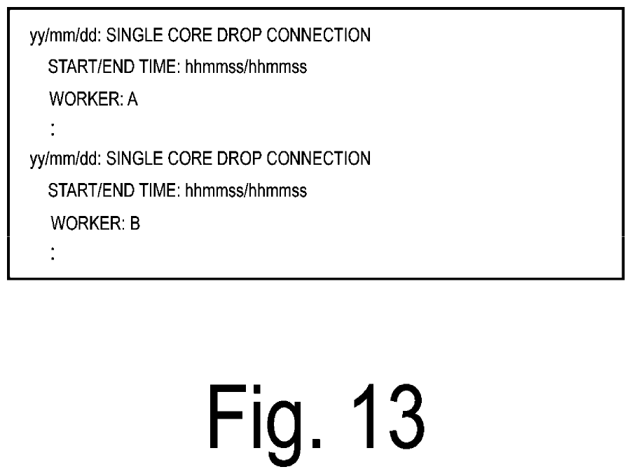

FIG. 13 is a diagram illustrating one example of a history of a work activity target object.

In the example illustrated in FIG. 13, a history of “closure No. XXX” corresponding to the type and the ID of the node “work target object” in the first basic block displayed as an analysis result of each work node includes work date, work activity name, process start/end time, and worker name.

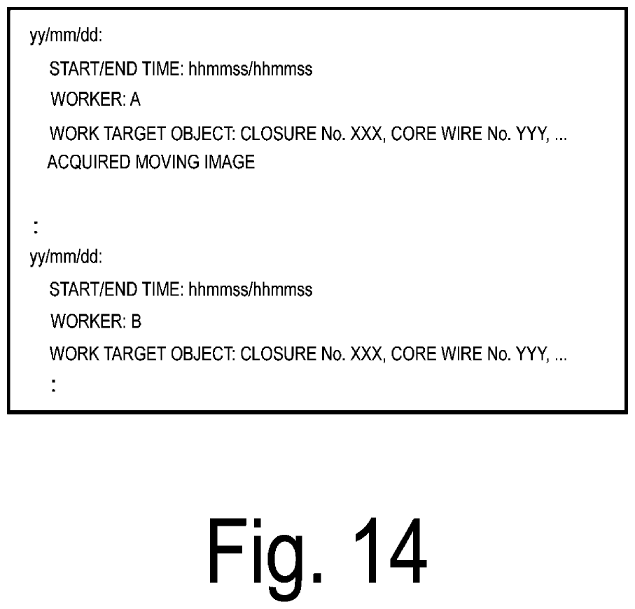

FIG. 14 is a diagram illustrating one example of a history of a work activity.

In the example illustrated in FIG. 14, a history of a work activity “work single core drop connection” displayed as an analysis result of a work node with the work activity name “work single drop connection” includes work date, work activity name, process start/end time, worker name, type of work target object, work target object ID, acquired moving image, and the like. Drill down can be implemented by following the links among these histories.

Next, a description will be given on (2-1): work proficiency determination by analyst. The work proficiency determination function unit 21 of the server 100 executes processing to implement (2-1).

In (2-1), at least one of a cumulative work time, a cumulative run count, a standard work time, vital information, and a history of whether a work performance was good or bad is used to automatically determine the proficiency of the worker in the work.

In (1-3), it is assumed that the work time, procedure, vital information, and a history of whether the work was good or bad of the worker in each process of the work are assumed to be accumulated in the database 200.

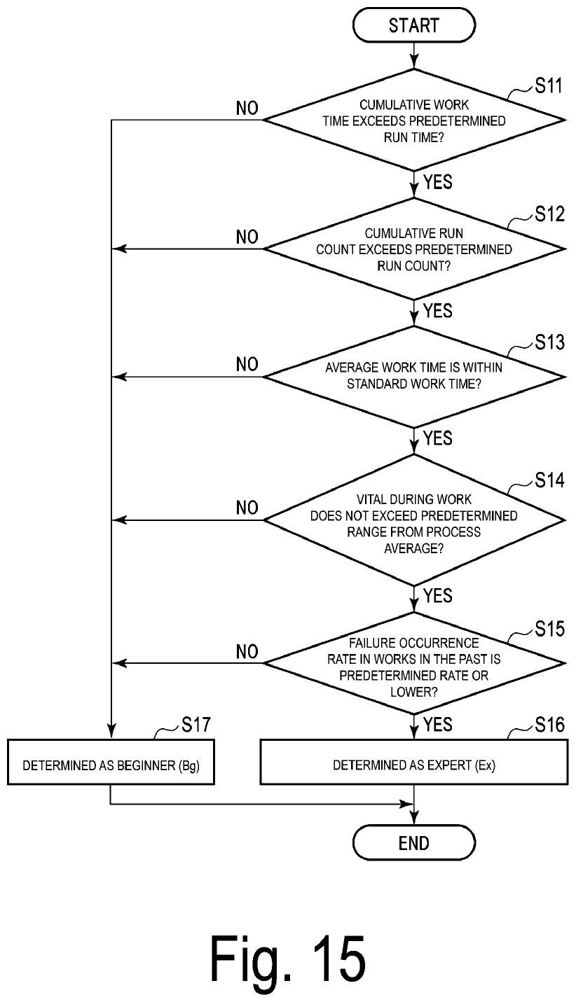

FIG. 15 is a flowchart illustrating one example of a processing operation related to work proficiency determination.

First or all, the work proficiency determination function unit 21 sets a work activity and a worker as targets of proficiency analysis in accordance with an operation by the analyst, and determines whether the cumulative work time of the worker in this work activity thus set exceeds a predetermined run time (S11).

In accordance with a determination that the cumulative work time exceeds the predetermined run time, the work proficiency determination function unit 21 determines whether the cumulative run count of the worker exceeds a predetermined run count (S12).

In accordance with a determination that the cumulative run count exceeds the predetermined run count, the work proficiency determination function unit 21 determines whether an average work time of the worker is within a standard work time (S13).

In accordance with a determination that the average work time is within the standard work time, the work proficiency determination function unit 21 determines whether the worker vital during the process average does not exceed a predetermined range from a process average (S14).

In accordance with a determination that the above-mentioned vital does not exceed the predetermined range from the process average, it is determined whether a failure occurrence rate of cases of the same type work activity performed by the same worker in the past is equal to or lower than a predetermined rate, based on the history of whether the work was good or bad (S15).

A result of the determination in S15 is accumulated in the database 200, as a result of determining whether each work activity performed was good or bad.

In accordance with a determination that the result in S15 is “Yes”, the work proficiency determination function unit 21 determines that the proficiency of the worker ascribed as described above is “Expert (Ex)” (S16).

When the result in S11, S12, S13, S14, or S15 is “No”, the work proficiency determination function unit 21 determines that the proficiency is “beginner Bg” (S17).

The proficiency of the worker in the work is registered in the database 200 while being associated with nodes related to the worker.

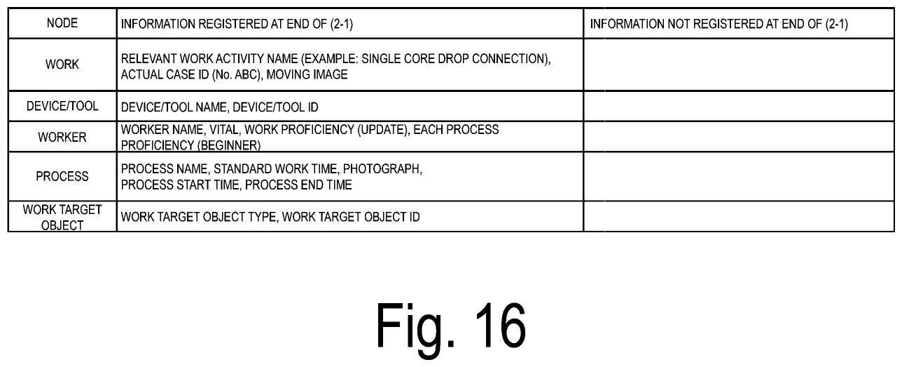

FIG. 16 is a diagram illustrating, in a tabular format, one example of information registered through the work proficiency determination processing. The example illustrated in FIG. 16 is different from the example illustrated in FIG. 10 in that the information related to the work proficiency is updated in accordance with the determination result described above.

Next, a description will be given on (2-2): process proficiency determination by analyst. The process proficiency determination function unit 22 of the server 100 executes processing to implement (2-2).

In (2-2), the proficiency of the worker in each process is automatically determined based on at least one of a cumulative process time, a cumulative run count, and a standard work time. This proficiency is also determined for a common process in different works.

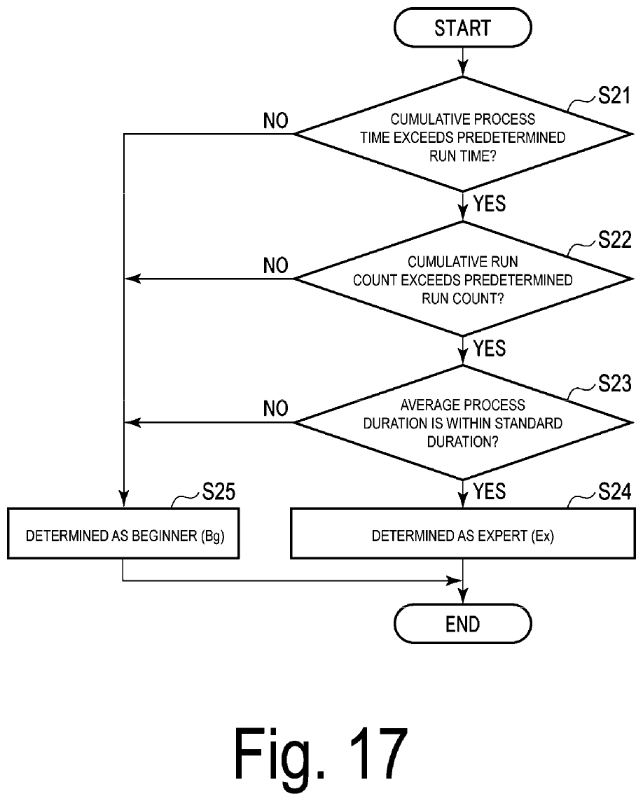

FIG. 17 is a flowchart illustrating one example of a processing operation related to a process proficiency determination.

First or all, the process proficiency determination function unit 22 sets a process and a worker as targets of proficiency analysis in accordance with an operation by the analyst, and determines whether the cumulative process time of the worker in this process thus set exceeds a predetermined run time (S21).

In accordance with a determination that the cumulative process time exceeds the predetermined run time, the process proficiency determination function unit 22 determines whether the cumulative run count of the process by the worker exceeds a predetermined run count (S22).

In accordance with a determination that the cumulative run count of the process exceeds the predetermined run count, the process proficiency determination function unit 22 determines whether an average process duration of the worker in the set process is within a standard duration (S23).

In accordance with a determination that the result in S23 is “Yes”, the process proficiency determination function unit 22 determines that the proficiency of the worker ascribed as described above in the process set as described above is “Expert (Ex)” (S24).

When the result in S21, S22, or S23 is “No”, the process proficiency determination function unit 22 determines that the proficiency is “beginner Bg” (S25).

The proficiency of the worker in the process is registered in the database 200 while being associated with nodes related to the worker.

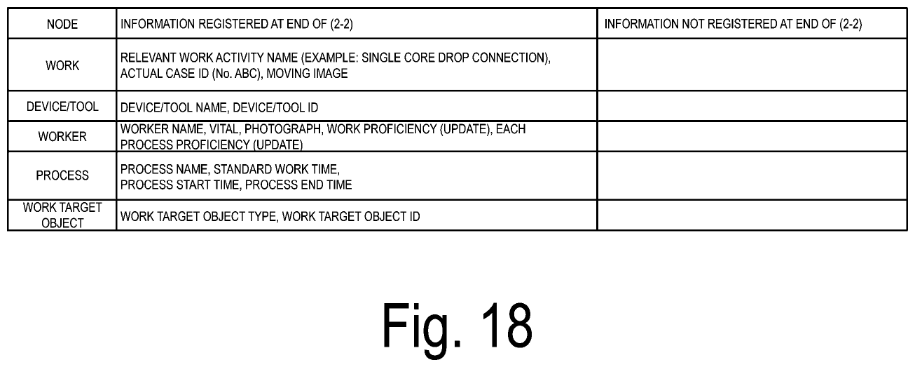

FIG. 18 is a diagram illustrating, in a tabular format, one example of information registered through the process proficiency determination processing. The example illustrated in FIG. 18 is different from the example illustrated in FIG. 16 in that the information related to the process proficiency is updated in accordance with the determination result described above.

Next, a description will be given on (2-3): display advice corresponding to proficiency by analyst.

The advice display function unit 23 of the server 100 executes processing to implement (2-3) divided into (2-3-1) and (2-3-2) below.

(2-3-1)

It is assumed that an additional advice table is registered in the database 200 for a case of additionally displaying an advice regarding a process on the worker's IoT device or smartphone, depending on whether the proficiency of the worker for the process is expert (Ex) or beginner (Bg).

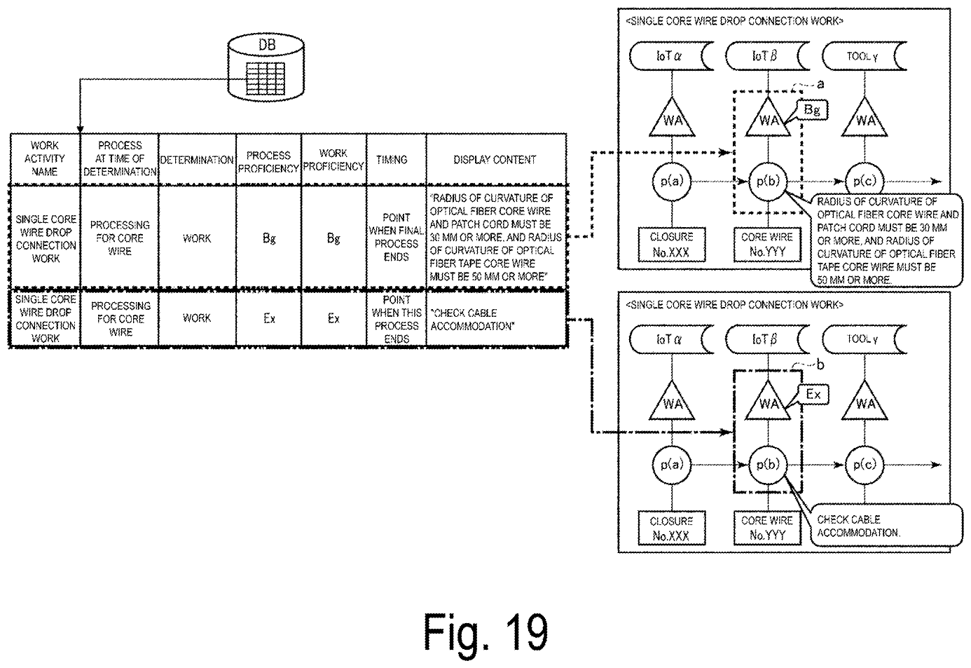

FIG. 19 is a diagram illustrating, in a tabular format, one example of the contents of an advice for a process displayed in accordance with the proficiency.

A first example in the additional advice table illustrated in FIG. 19 corresponds to a combination of the proficiency of a worker A and a process in a case where: a work activity name of a work at the time when the additional advice table is determined to be displayed is “single core drop connection work”; a process at the time of the display determination is “processing for core wire”; a type of the additional advice table display determination is “process”; and the proficiency of the worker A for the process is “Bg”.

In this case, the advice display function unit 23 makes an additional advice “radius of curvature of core wire of optical fiber and patch cord must be 30 mm or more, and radius of curvature of optical fiber table core wire must be 50 mm or more” displayed on an IoT device or a smartphone used by the worker performing the process in real time, that is, at a timing “when the process ends”, in association with a node of the process and a node of the worker at the time of the determination surrounded by a in FIG. 19 on a basic block display screen. The process proficiency “Bg” may be associated with the node of the worker at the time of the determination on this screen.

A second example in the additional advice table illustrated in FIG. 19 corresponds to a combination of a proficiency of the worker A and a process in a case where: a work activity name of a work at the time of display determination is “single core drop connection work”; a process at the time of display determination is “core wire target processing”; a type of the additional advice display determination is “process”; and the process proficiency of the worker A for the process is “Ex”.

In this case, the advice display function unit 23 makes an additional advice “check cable accommodation” at a timing “when the process ends” on an IoT device or a smartphone used by the worker executing the process, while being associated with a node of the process and a node of the worker surrounded by b in FIG. 19 on the basic block display screen. The process proficiency “Ex” may be associated with the node of the worker at the time of the determination on this screen.

(2-3-2)

It is assumed that an additional advice table is registered in the database 200 for a case where there is a process for which an advice is additionally displayed at an appropriate timing, depending on whether the proficiency of the worker for the entire work node is expert (Ex) or beginner (Bg).

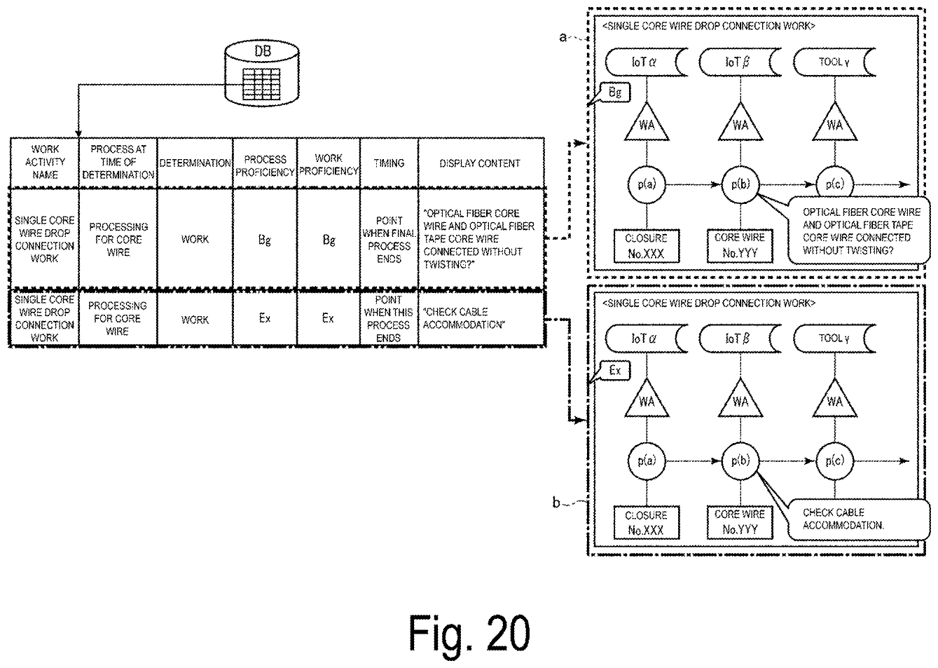

FIG. 20 is a diagram illustrating, in a tabular format, one example of the contents of an advice for displayed in accordance with the proficiency at an appropriate timing.

A first example in the additional advice table illustrated in FIG. 20 corresponds to a combination of the proficiency of a worker A and a process in a case where: a work activity name of a work at the time when the additional advice table is determined to be displayed is “single core drop connection work”; a process at the time of the display determination is “processing for core wire”; a type of the additional advice table display determination is “work”; and the proficiency of the worker A for the work is “Bg”.

In this case, the advice display function unit 23 makes an additional advice “optical fiber core wire and optical fiber table core wire connected without being twisted?” displayed on an IoT device or a smartphone used by the worker executing the work in real time, that is, at a timing “when final process ends”, while being associated with a node of the work at the time of determination on the basic block display screen (see a in FIG. 20). The work proficiency “Bg” may be associated with the work node at the time of the determination on this screen.

A second example in the additional advice table illustrated in FIG. 20 corresponds to a combination of a proficiency of the worker A and a process in a case where: a work activity name of a work at the time of display determination is “single core drop connection work”; a process at the time of display determination is “core wire target processing”; a type of the additional advice display determination is “work”; and the work proficiency of the worker A for the work is “Ex”.

In this case, the advice display function unit 23 makes an additional advice “check cable accommodation” in real time, that is, at a timing “when the process ends” in this example, on an IoT device or a smartphone used by the worker executing the work, while being associated with a node of the work at the time of determination on the basic block display screen (see b in FIG. 20). The work proficiency “Ex” may be associated with the work node at the time of the determination on this screen.

Although a message with an advice is displayed on a device of a worker in the examples described above, an advice may be output to the worker in any way. For example, a voice reading the advice may be output from the device of the worker.

Next, a selection condition for a type to be assigned to each node of the basic block will be described.

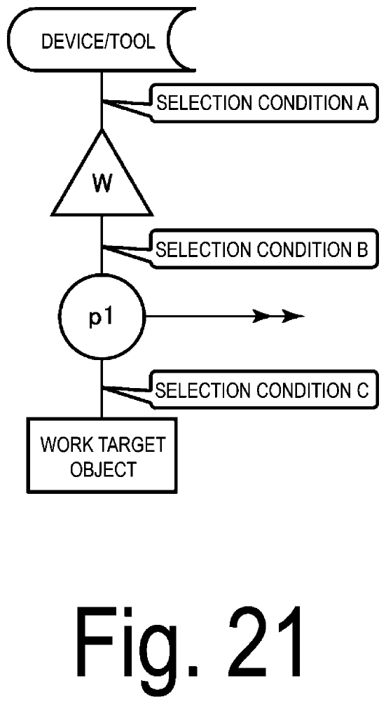

FIG. 21 is a diagram illustrating one example of the selection condition.

Selection conditions A-1, A-2, B-1, B-2, C-1, C-2, D-1, and D-2 will each be described below.

Among these, A-1, B-1, C-1, and D-1 are selection conditions in a case where pre-assignment is performed, and A-2, B-2, C-2, and D-2 are selection conditions in a case where pre-assignment is not performed. This assignment can be performed by the server 100 in accordance with an operation by the analyst.

-Selection condition A (assignment of worker and device/tool)

(A-1) A type of node “worker” and a type of node “device/tool” are preassigned.

(A-2) A type of node “worker” and a type of node “device/tool” are not preassigned, but are assigned at a time of login to the device (IoT device) for the work.

Selection condition B (assignment of worker and process)

(B-1) A type of a node “work” and a type of node “process” required for the work are preassigned.

(B-2) A type of node “worker” and a type of a series of nodes “process” are not preassigned, but are assigned when the worker logs into the device and downloads a procedure for the work.

Selection condition C (assignment of process and work target object)

(C-1) A type of a node “process” and a type of node “work target object” are preassigned.

(C-2) A type of a node “process” and a type of node “work target object” are not preassigned, but are assigned when the worker inputs the work target object to the device in the system.

Selection condition D (node associated with information acquired by device)

(D-1) Information acquired by the device and a type of node “device/tool” are preassigned.

(D-2) An extension (jpg, mp4, . . . ) of the information acquired by the device and an assignment table of a node “device/tool” are generated in advance, and the server 100 associates the information with the node based on the assignment table when the device obtains the information.

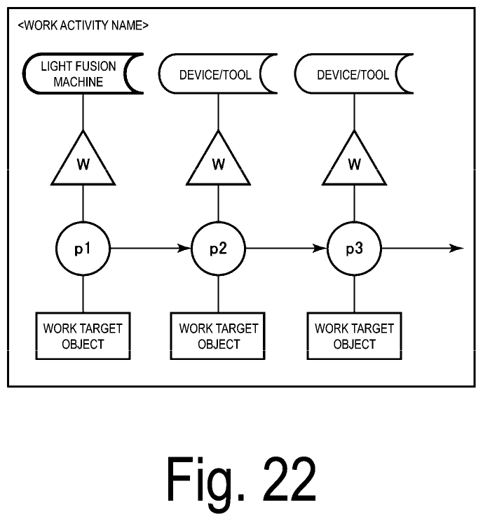

FIG. 22 is a diagram illustrating one example of a configuration of the basic block when the selection condition D-1 is applied.

As illustrated in FIG. 22, under the selection condition D-1, the type assigned for the node “device/tool” is “light fusion machine”.

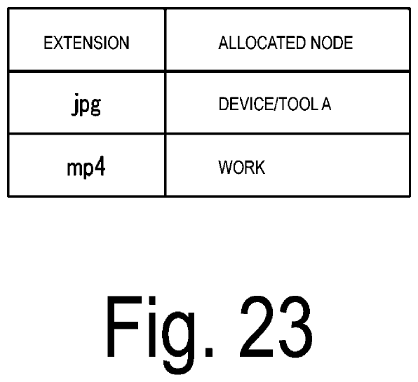

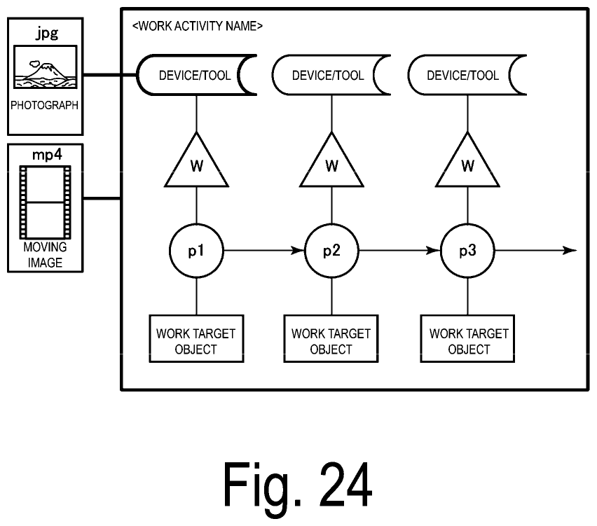

FIG. 23 is a diagram illustrating, in a tabular format, one example of the relationship between extensions and the assigned nodes when the selection condition D-2 is applied. FIG. 24 is a diagram illustrating one example of a configuration of the basic block with device acquired information and a node associated with each other when a selection condition is applied. In the example illustrated in FIGS. 23, 24, a node to which information with an extension “jpg” is assigned is a node “device/tool” in the first basic block, and a node to which information with an extension “mp4” is assigned is a work node. Information indicating this relationship is stored in the database 200.

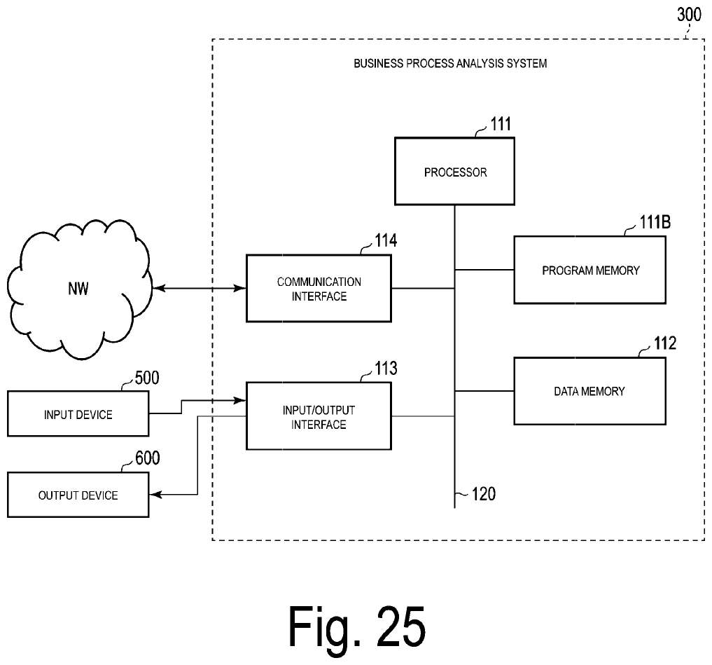

FIG. 25 is a block diagram illustrating one example of a hardware configuration of a business process analysis system according to an embodiment of the present invention.

In the example illustrated in FIG. 25, the business process analysis system 300 according embodiment described above is constituted by a server computer or a personal computer, for example, and has a hardware processor 111 such as a CPU. A program memory 111B, a data memory 112, an input/output interface 113, and a communication interface 114 are connected to the hardware processor 111 through a bus 120.

The communication interface 114 includes, for example, one or more wireless communication interface units to allow transmission/reception of information to/from a communication network NW. As the wireless interface, for example, an interface adopting a small power wireless data communication standard such as a wireless local area network (LAN) is used.

An input device 500 and an output device 600 for an operator, that are provided in server 100 of the business process analysis system 300, are connected to the input/output interface 113.

The input/output interface 113 receives operation data input by an operator through the input device 500, such as a keyboard, a touch panel, a touch pad, or a mouse, and performs processing for outputting output data to the output device 600 including a display device employing liquid crystals, organic electroluminescence (EL), or the like to display the output data. Note that as the input device 500 and the output device 600, a device built into a server 100 may be used, or an input device and an output device of another information terminal communicable with the server 100 via the network NW may be used.

The program memory 111B is a memory in which a non-volatile memory such as a hard disk drive (HDD) or a solid state drive (SSD) that can be written and read at any time and a non-volatile memory such as a read only memory (ROM) are used in combination as a non-transitory tangible storage medium, in which a program necessary to perform various types of control processing according to an embodiment is stored.

The data memory 112 is a memory in which, for example, the non-volatile memory described above and a volatile memory such as a random access memory (RAM) are used in combination as a tangible storage medium, and is used to store various data acquired and created in the course of performing various types of processing.

The business process analysis system 300 according to an embodiment of the present invention may be configured as an information processing apparatus including, as processing function units implemented by software, the work registration function unit 11, the actual case data registration function unit 12, the data accumulation function unit 13, the analysis function unit 14, the work proficiency determination function unit 21, the process proficiency determination function unit 22, and the advice display function unit 23 illustrated in FIG. 1.

The database 200 may be configured using the data memory 112 illustrated in FIG. 25. However, the database 200 is not an essential configuration in the business process analysis system 300, and may be provided in an external storage medium, such as a universal serial bus (USB) memory or a storage device, such as a database server in a cloud.

The processing function units of the above described components (the work registration function unit 11, the actual case data registration function unit 12, the data accumulation function unit 13, the analysis function unit 14, the work proficiency determination function unit 21, the process proficiency determination function unit 22, and the advice display function unit 23) may each be implemented with the hardware processor 111 reading and executing a program stored in the program memory 111B. Note that some or all of these processing function units may be implemented by other various forms including an integrated circuit such as an application specific integrated circuit (ASIC) or a field-programmable gate array (FPGA).

As described above, in the business process analysis system according to an embodiment of the present invention, a basic block represents each process, and a series of processes and the like represents each work. The system manages these pieces of information in a database and displays various procedures on a smartphone or the like of a worker via a server. Thus, with various devices, a wide variety of data may be acquired, collectively managed, and visualized so that a business process can be recognized. Thus, an analysis target (perspective) can be changed easily, and an advice and warning can be given in real time for each process and for each person, based on an analysis result.

Further, a scheme described in each embodiment can be stored in a recording medium such as a magnetic disk (a Floppy (registered trade mark) disk, a hard disk, or the like), an optical disc (a CD-ROM, a DVD, an MO, or the like), and a semiconductor memory (a ROM, a RAM, a flash memory, or the like), or transferred by a communication medium for distribution, as a program (a software unit) that can be executed by a computing device (a computer). Note that the program stored on the medium side includes a setting program for configuring, in a computing device, a software unit (including not only an execution program but also a table and a data structure) to be executed by the computing device. The computing device which realizes the present apparatus reads the program recorded in the recording medium, optionally builds the software unit by the setting program, and executes the above-described processing by controlling the operation with the software unit. Note that the recording medium referred to herein is not limited to a recording medium for distribution, but includes a storage medium such as a magnetic disk or a semiconductor memory provided in a computing machine or a device connected via a network.

It is to be noted that the present invention is not limited to the above embodiments and can be variously modified in the implementation stage without departing from the gist of the present invention. An appropriate combination of the embodiments can also be implemented, in which a combination of their effects can be obtained. Further, the above embodiments include various inventions, which can be designed by combining constituent elements selected from a plurality of constituent elements disclosed here. For example, a configuration in which some constituent elements are removed from all the constituent elements shown in the embodiments can be designed as an invention if the problems can be solved and the effects can be achieved.

### REFERENCE SIGNS LIST

100: Server

200: Databases

11: Work registration function unit

12: Actual case data registration function unit

13: Data accumulation function unit

14: Analysis function unit

21: Work proficiency determination function unit

22: Process proficiency determination function unit

23: Advice display function unit

1. An information processing apparatus comprising:
a processor; and
a storage medium having computer program instructions stored thereon, when executed by the processor, perform to:
a registration processing unit configured to register, in a storage device, a work node made up of basic blocks, corresponding to respective processes, connected to each other by a link, the work node including a first node indicating a device/tool used by a worker for performing their work, a second node indicating the worker, a third node indicating a process that is a unit of the work activity, and a fourth node indicating a work target object of the worker in the process; and
an analysis processing unit configured to execute analysis processing of analyzing at least one of a history of a work activity performed by a predetermined worker, a history of a work activity performed on a predetermined work target object, and a history indicating a worker and a work target object related to a predetermined work, based on the work node registered in the storage device by the registration processing unit.

2. The information processing apparatus according to claim 1, wherein
the registration processing unit further registers a numerical value related to the work activity performed by the worker, in the storage device, and
the information processing apparatus further comprises a determination processing unit configured to determine a proficiency of the worker in the work, based on the numerical value related to the work registered by the registration processing unit.

3. The information processing apparatus according to claim 2, wherein
the registration processing unit registers vital-related information on the worker in the storage device, and
the determination processing unit executes determination processing of determining the proficiency of the worker in the work, based on information including the numerical value related to the work and the vital-related information registered by the registration processing unit.

4. The information processing apparatus according to claim 2, wherein
the storage device further stores information indicating an advice to the worker, the advice corresponding to the proficiency of the worker in their work activity, and
the information processing apparatus further comprises an output processing unit configured to executed output processing of searching the storage device for information indicating the advice corresponding to the work to be performed by the worker and the proficiency determined by the determination processing unit for the work, and outputting the information.

5. The information processing apparatus according to claim 3, wherein
the storage device further stores information indicating an advice to the worker, the advice corresponding to the proficiency of the worker in their work activity, and
the information processing apparatus further comprises an output processing unit configured to executed output processing of searching the storage device for information indicating the advice corresponding to the work to be performed by the worker and the proficiency determined by the determination processing unit for the work, and outputting the information.

6. An information processing method at an information processing apparatus, the method comprising:
executing registration processing of registering, in a storage device, a work node made up of basic blocks, corresponding to respective processes, connected to each other by a link, the work node including a first node indicating a device/tool used by a worker for performing their work, a second node indicating the worker, a third node indicating a process that is a unit of the work activity, and a fourth node indicating a work target object of the worker in the process; and
analyzing at least one of a history of a work activity performed by a predetermined worker, a history of a work activity performed on a predetermined work target object, and a history indicating a worker and a work target object related to a predetermined work, based on the work node registered in the storage device by the registration processing.
